(19) United States
(12) Patent Application Publication
(10) Pub. No.: US 2025/0054491 A1
(43) Pub. Date: Feb. 13, 2025

(54) SMART AUDIO SEGMENTATION USING LOOK-AHEAD BASED ACOUSTO-LINGUISTIC FEATURES

(71) Applicant: MICROSOFT TECHNOLOGY LICENSING, LLC, Redmond, WA (US)

(72) Inventors: Sayan Dev PATHAK, Kirkland, WA (US); Hosam Adel KHALIL, Issaquah, WA (US); Naveen PARIHAR, Bellevue, WA (US); Piyush BEHRE, Santa Clara, CA (US); Shuangyu CHANG, Davis, CA (US); Christopher Hakan BASOGLU, Everett, WA (US); Sharman W TAN, Fremont, CA (US); Eva SHARMA, San Jose, CA (US); Jian WU, Bellevue, WA (US); Yang LIU, Beijing (CN); Edward C LIN, Beijing (CN); Amit Kumar AGARWAL, Redmond, WA (US)

(21) Appl. No.: 18/721,121

(22) PCT Filed: Dec. 22, 2021
(86) PCT No.: PCT/CN2021/140296

§ 371 Date: Jun. 17, 2024

(51) Int. Cl. G10L 15/04; G10L 15/01

(52) U.S. Cl. CPC G10L 15/04; G10L 15/01

(57) ABSTRACT

Systems and methods are provided for smart audio segmentation using look-ahead based acousto-linguistic features. For example, systems and methods are provided for obtaining audio, processing the audio, identifying a potential segmentation boundary within the audio, and determining whether to generate a segment break at the potential segmentation boundary. One or more look-ahead words occurring after the potential segmentation boundary are identified, wherein an acoustic segmentation score and a language segmentation score associated with the potential segmentation boundary and the one or more look-ahead words are generated. Systems then either refrain from generating a segment break at the potential segmentation boundary or generate the segment break at the potential segmentation boundary based on the acoustic and/or language segmentation score at least meeting or exceeding a segmentation score threshold.

### BACKGROUND

Automatic speech recognition systems and other speech processing systems are used to process and decode audio data to detect speech utterances (e.g., words, phrases, and/or sentences). The processed audio data is then used in various downstream tasks such as search-based queries, speech to text transcription, language translation, etc. Oftentimes, the processed audio data needs to be segmented into a plurality of audio segments before being transmitted to downstream applications, or to other processes in streaming mode.

Conventional systems are configured to perform audio segmentation for continuous speech today based on timeout driven logic. In such speech recognition systems, audio is segmented after a certain amount of silence has elapsed at the end of a detected word (i.e., when the audio has “timed-out”). This time-out-based segmentation does not consider the fact that somebody may naturally pause in between a sentence while thinking what they would like to say next. Consequently, the words are often chopped off in the middle of a sentence before somebody has completed elucidating a sentence. This degrades the quality of the output for data consumed by downstream post-processing components, such as by a punctuator or machine translation components. Previous systems and methods were developed which included neural network-based models that combined current acoustic information and the corresponding linguistic signals for improving segmentation. However, even such approaches, while superior to time-out-based logic, were found to over-segment the audio leading to some of the same issues as the time-out based logic segmentation.

In view of the foregoing, there is an ongoing need for improved systems and methods for segmenting audio in order to generate more accurate segments of audio that correspond to complete speech utterances included in the audio.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems, methods and devices used for segmenting audio based on smart audio segmentation using look-ahead based acousto-linguistic features.

Some disclosed systems are configured to obtain audio which includes electronic data with natural language. The systems process the audio with a decoder to recognize utterances included in the audio. The systems also identify a potential segmentation boundary within the speech utterances. The potential segmentation boundary occurs after a beginning of the audio. After identifying the potential segmentation boundary, the systems identify one or more look-ahead words to use in the audio. The one or more look-ahead words occur in the audio subsequent to the potential segmentation boundary and are used to evaluate whether or not to generate a segment break in the audio at the potential segmentation boundary.

Disclosed systems are configured to generate an acoustic segmentation score and a language segmentation score associated with potential segmentation boundary. The systems also evaluate the acoustic segmentation score against an acoustic segmentation score threshold and evaluate the language segmentation score against a language segmentation score threshold or a combination of the scores against a joint score-based threshold in combination with any time-based signals (say an elapsed time duration where no new words have been detected). Notably, as disclosed herein, the systems refrain from generating the segment break at the potential segmentation boundary in the audio when it is determined that either (i) the acoustic segmentation score fails to meet or exceed the acoustic segmentation score threshold or (ii) the language segmentation score fails to meet or exceed the language segmentation score threshold. Alternatively, the systems generate the segment break at the potential segmentation boundary in the audio when it is determined that at least the language score meets or exceeds the language segmentation score threshold. Yet another alternate, allows the system to generate a segment break when a combined audio and language score exceeds a joint acousto-linguistic scoring threshold.

Disclosed systems are also configured for determining how many one or more look-ahead words to use in an analysis of whether to generate a segment break in an audio at a potential segmentation boundary. For example, systems obtain electronic data comprising the audio at which point the systems identify at least one of: a type or a context associated with the audio. After identifying a type and/or a context associated with the audio, the systems determine a quantity of one or more look-ahead words included in the audio to later utilize when determining whether to generate a segment break in the audio at a potential segmentation boundary based on at least one of the type or the context associated with the audio. In such configurations, the one or more look-ahead words are positioned sequentially after the potential segmentation boundary within the audio.

Disclosed systems are also configured to determine how many look-ahead words to use in the analysis of whether to generate a segment break before generating an acoustic segmentation score and/or language segmentation score which is/are evaluated for determining whether to generate the segment break at the potential segmentation boundary.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments.

FIG. 2 illustrates an example embodiment of a process flow diagram for determining when to segment audio.

FIG. 3 illustrates an example embodiment of an audio being analyzed for language and/or acoustic features in order to determine at which points to segment the audio.

FIG. 4 illustrates various example embodiments of identifying a potential segmentation boundary and generating an acoustic and/or language score segmentation based on one or more look-ahead words.

FIG. 5 illustrates an example embodiment of identifying a potential segmentation boundary and determining whether to generate a segment break based on a context and/or type associated with the audio.

FIG. 6 illustrates one embodiment of a flow diagram having a plurality of acts for generating a segment break.

FIG. 7 illustrates another embodiment of a flow diagram having a plurality of acts for determining an amount to look ahead, or a quantity of look-ahead words to use in analyzing whether to generate a segment break at previously identified potential segmentation boundary.

FIG. 8 illustrates one embodiment of a flow diagram having a plurality of acts for segmenting audio by determining an amount to look ahead, or a quantity of look-ahead words, and determining whether to segment the audio based on an acoustic and/or language segmentation score.

### DETAILED DESCRIPTION

Disclosed embodiments are directed towards improved systems, methods, and frameworks for determining whether to segment audio at a potential segmentation boundary. The disclosed embodiments include systems and methods that are specifically configured to evaluate a potential segmentation boundary based on one or more look-ahead words

More particularly, some of the disclosed embodiments are directed to improved systems and methods segmenting audio based on incorporating prosodic signals as well as language-based signals to better generate sentence fragments that line up with a linguistically interpretable set of words.

The disclosed embodiments provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

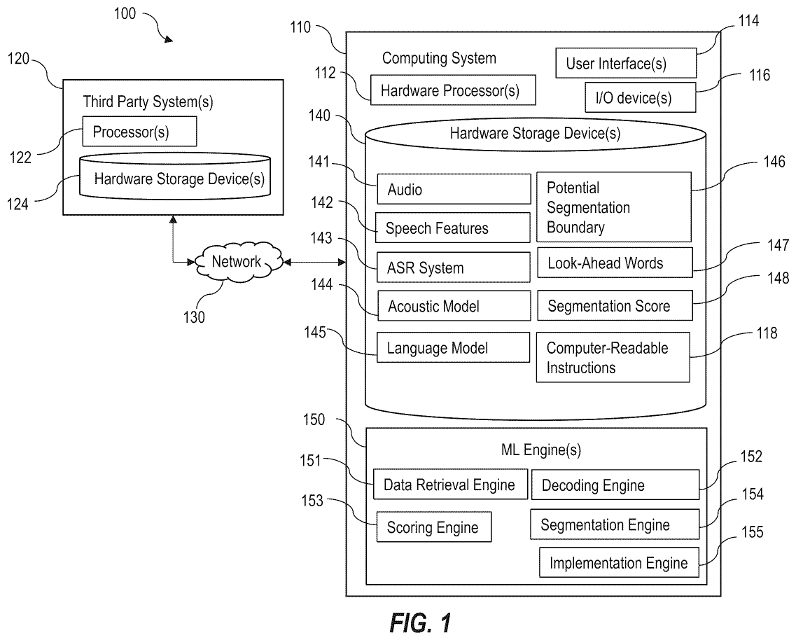

Attention will now be directed to FIG. 1, which illustrates components of a computing system 110 which may include and/or be used to implement aspects of the disclosed invention. As shown, the computing system includes a plurality of machine learning (ML) engines, models, neural networks, and data types associated with inputs and outputs of the machine learning engines and models.

Attention will be first directed to FIG. 1, which illustrates the computing system 110 as part of a computing environment 100 that also includes third-party system(s) 120 in communication (via a network 130) with the computing system 110. The computing system 110 is configured segment audio based on looking-ahead at acousto-linguistic features that occur after a potential segmentation boundary. The computing system 110 is also configured to determine how many look-ahead words to analyze after the potential segmentation boundary.

The computing system 110, for example, includes one or more processor(s) (such as one or more hardware processor(s)) 112 and a storage (i.e., hardware storage device(s) 140) storing computer-readable instructions 118 wherein one or more of the hardware storage device(s) 140 is able to house any number of data types and any number of computer-readable instructions 118 by which the computing system 110 is configured to implement one or more aspects of the disclosed embodiments when the computer-readable instructions 118 are executed by the one or more processor(s) 112. The computing system 110 is also shown including user interface(s) 114 and input/output (I/O) device(s) 116.

As shown in FIG. 1, hardware storage device(s) 140 is shown as a single storage unit. However, it will be appreciated that the hardware storage device(s) 140 is, a distributed storage that is distributed to several separate and sometimes remote systems and/or third-party system(s) 120. The computing system 110 can also comprise a distributed system with one or more of the components of computing system 110 being maintained/run by different discrete systems that are remote from each other and that each perform different tasks. In some instances, a plurality of distributed systems performs similar and/or shared tasks for implementing the disclosed functionality, such as in a distributed cloud environment.

The hardware storage device(s) 140 are configured to store and/or cache in a memory store the different data types including audio 141, speech features 142, potential segmentation boundaries 146, look-ahead words 147, and segmentation scores 148, described herein.

The storage (e.g., hardware storage device(s) 140) includes computer-readable instructions 118 for instantiating or executing one or more of the models and/or engines shown in computing system 110 (e.g., ASR system 143, acoustic model 144, and language model 145). The models are configured as machine learning models or machine learned models, such as deep learning models and/or algorithms and/or neural networks. In some instances, the one or more models are configured as engines or processing systems (e.g., computing systems integrated within computing system 110), wherein each engine comprises one or more processors (e.g., hardware processor(s) 112) and computer-readable instructions 118 corresponding to the computing system 110. In some configurations, a model is a set of numerical weights embedded in a data structure, and an engine is a separate piece of code that, when executed, is configured to load the model and compute the output of the model in context of the input audio.

The audio 141 comprises both natural language audio and simulated audio. The natural language audio is obtained from a plurality of locations and applications. In some instances, natural language audio is extracted from previously recorded files such as video recordings having audio or audio-only recordings. Some examples of recordings include videos, podcasts, voicemails, voice memos, songs, etc. Natural language audio is also extracted from actively streaming content which is live continuous speech such as a news broadcast, phone call, virtual or in-person meeting, etc. In some instances, a previously recorded audio file is streamed. Natural audio data comprises spoken language utterances without a corresponding clean speech reference signal. Natural audio data is recorded from a plurality of sources, including applications, meetings comprising one or more speakers, ambient environments including background noise and human speakers, etc. It should be appreciated that the natural language audio comprises one or more spoken languages of the world's spoken languages.

Simulated audio data comprises a mixture of simulated clean speech (e.g., clean reference audio data) and one or more of: room impulse responses, isotropic noise, or ambient or transient noise for any particular actual or simulated environment or one that is extracted using text-to-speech technologies. Thus, parallel clean audio data and noisy audio data is generated using the clean reference audio data on the one hand, and a mixture of the clean reference audio data and background noise data. Simulated noisy speech data is also generated by distorting the clean reference audio data.

Speech features 142 include acoustic features and linguistic features that have been extracted from processing the audio 141. Acoustic features include audio features such as vowel sounds, consonant sounds, length, and emphasis of individual phonemes, as well as speaking rate, speaking volume, and whether there are pauses in between words. Linguistic features are characteristics used to classify audio data as phonemes and words. Linguistic features also include grammar, syntax, and other features associated with the sequence and meaning of words detected in audio data. These words form speech utterances that are recognized by different systems and models.

In some instances, the speech features 142 are computed in real-time and/or at run-time, wherein the speech features 142 are kept in the system memory during the decoding of the audio. In such instances, the systems are configured to compute the acoustic features directly from the input acoustic data. The systems are trained to automatically and implicitly derive the acoustic features needed for subsequent data processing and analysis.

Potential segmentation boundaries 146 are locations in audio that are predicted to correspond to an end of a speech utterance. For example, the potential segmentation boundary can be located just after a particular word that is predicted to be the last word in a sentence or is a location between two sequential words wherein the system will then make a further determination on whether or not to generate a segment break at the potential segmentation boundary. The goal of the disclosed embodiments is to identify potential segmentation boundaries at the ends of speech utterances, wherein the systems are then able to generate and transmit segments of the audio according to the intentions of the original speaker.

Hardware storage device(s) 140 also store look-ahead words such that the acoustic model 144 and/or language model 145 is able to access the look-ahead words. The look-ahead words are words following a potential segmentation boundary that are used in the determination of whether or not to segment the audio at the potential segmentation boundary. The look-ahead words are used to determine whether the word at the potential segmentation boundary is in fact the last word of the speech utterance, or whether the speaker had merely paused but is continuing the same speech utterance in subsequently detected words. In some embodiments, the system identifies a particular number of words to analyze. Additionally, or alternatively, the system identifies a particular quantity of audio that corresponds to a time interval to look ahead (rather than a specific number of words or utterances).

In some embodiments, the system identifies an acoustic and/or linguistic feature that marks a first and/or last look-ahead word. For example, an acoustic feature might be a pause in speaking, wherein the system will analyze every word after the potential segmentation boundary until another pause is detected, wherein the first look-ahead word is the first word following the potential segmentation boundary and the last look-ahead word is the word occurring just before the detected pause. Additional acoustic features that can be used as look-ahead quantity markers include a change in speaking rate, a change in speaker voice, a change in speaker volume, etc. Similarly, the system is configurable to determine a quantity of look-ahead words based on a change in a linguistic feature or a new occurrence of a particular linguistic feature. In some instances, the number of look-ahead words is determined based on a context and/or a type of audio associated with the audio 141.

Computing system 110 also stores one or more segmentation scores 148. The segmentation scores 148 include language segmentation scores and acoustic segmentation scores. Language segmentation scores are calculated based on a correlation between linguistic features identified before the potential segmentation boundary and linguistic features occurring after the potential segmentation boundary. Additionally, or alternatively, the segmentation scores 148 include a joint acousto-linguistic segmenation score. By calculating and evaluating segmentation score using the look-ahead words, the computing systems are better able to determine a more accurate segmentation score or provide a segmentation score analysis (i.e., probability that a segment break should be generated at the potential segmentation boundary) with a higher confidence score.

For example, if the linguistic features before the potential segmentation boundary have a low correlation to the linguistic features occurring after the potential segmentation boundary when a segmentation event occurs in the training data, the language segmentation model will likely output a high language segmentation score (i.e., meaning that there is a high probability that the audio should be segmented at the potential segmentation boundary). However, if the linguistic features before and after the potential segmentation boundary do have a high correlation to each other, this likely means that the audio should not be segmented at the potential segmentation boundary (e.g., the language segmentation model will output a low language segmentation score). The systems “learn” different types of correlations, or different scores of correlations, based on segmentation boundaries included in the training data. Thus, when the systems detect a potential segmentation boundary in the input audio that is similar to a training data segmentation data with a known segmentation score, the systems output a similar segmentation score and/or generate a segment break if applicable.

Acoustic segmentation scores are calculated based on a correlation between acoustic features identified before the potential segmentation boundary and acoustic features occurring after the potential segmentation boundary. For example, if the acoustic features before the potential segmentation boundary have a low correlation to the acoustic features occurring after the potential segmentation boundary, the acoustic segmentation model will likely output a high acoustic segmentation score (i.e., meaning that there is a high probability that the audio should be segmented at the potential segmentation boundary). However, if the acoustic features before and after the potential segmentation boundary do have a high correlation to each other, this likely means that the audio should not be segmented at the potential segmentation boundary (e.g., the acoustic segmentation model will output a low acoustic segmentation score).

An additional storage unit for storing machine learning (ML) Engine(s) 150 is presently shown in FIG. 1 as storing a plurality of machine learning models and/or engines. For example, computing system 110 comprises one or more of the following: a data retrieval engine 151, a decoding engine 152, a scoring engine 153, a segmentation engine 154, and an implementation engine 155, which are individually and/or collectively configured to implement the different functionality described herein.

For example, the data retrieval engine 151 is configured to locate and access data sources, databases, and/or storage devices comprising one or more data types from which the data retrieval engine 151 can extract sets or subsets of data to be used as training data. The data retrieval engine 151 receives data from the databases and/or hardware storage devices, wherein the data retrieval engine 151 is configured to reformat or otherwise augment the received data to be used in the speech recognition and segmentation tasks. Additionally, or alternatively, the data retrieval engine 151 is in communication with one or more remote systems (e.g., third-party system(s) 120) comprising third-party datasets and/or data sources. In some instances, these data sources comprise visual services that record or stream text, images, and/or video.

The data retrieval engine 151 accesses electronic content comprising audio 141 and/or other types of audio-visual data including video data, image data, holographic data, 3-D image data, etc. The data retrieval engine 151 is a smart engine that is able to learn optimal dataset extraction processes to provide a sufficient amount of data in a timely manner as well as retrieve data that is most applicable to the desired applications for which the machine learning models/engines will be used.

The data retrieval engine 151 locates, selects, and/or stores raw recorded source data wherein the data retrieval engine 151 is in communication with one or more other ML engine(s) and/or models included in computing system 110. In such instances, the other engines in communication with the data retrieval engine 151 are able to receive data that has been retrieved (i.e., extracted, pulled, etc.) from one or more data sources such that the received data is further augmented and/or applied to downstream processes. For example, the data retrieval engine 151 is in communication with the decoding engine 152 and/or implementation engine 155.

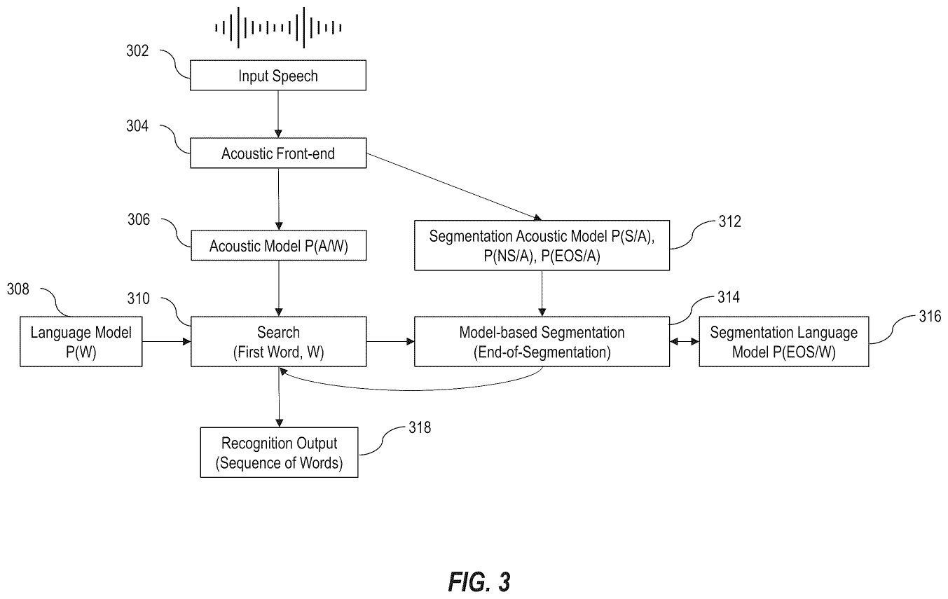

The decoding engine 152 is configured to decode and process the audio (e.g., audio 141). The output of the decoding engine is acoustic features and linguistic features. In some embodiments, the decoding engine 152 comprises the ASR system 143, an acoustic model 144, and/or a language model 145. In some instances, the decoding engine 152 is configured as an acoustic front-end (see FIG. 3).

The scoring engine 153 is configured to generate segmentation scores associated with a particular segmentation boundary. In some embodiments, the scoring engine 153 includes a language segmentation model and an acoustic segmentation model which output a language segmentation score and an acoustic segmentation score, respectively. In some instances, the scoring engine 153 is configured to generate a joint acousto-linguistic segmentation score. The scoring engine 153 is also configured to evaluate each segmentation score against the corresponding segmentation score threshold. The segmentation score threshold is tunable based on user input and/or automatically detected features of the audio.

The segmentation engine 154 is configured to generate segment breaks at the potential segmentation boundary based on the acoustic and/or language segmentation score meeting and/or exceeding their respective segmentation score threshold. The computing system, using the segmentation engine, refrains from generating the segment break at the potential segmentation boundary in the audio when it is determined that either (i) the acoustic segmentation score fails to meet or exceed the acoustic segmentation score threshold, or (ii) the language segmentation score fails to meet or exceed the language segmentation score. Alternatively, when it is determined that at least the language segmentation score meets or exceeds the language segmentation score threshold, the computing system uses the segmentation engine 154 to generate a segment break at the potential segmentation boundary.

The computing system 110 includes an implementation engine 155 in communication with any one of the models and/or ML engine(s) 150 (or all of the models/engines) included in the computing system 110 such that the implementation engine 155 is configured to implement, initiate, or run one or more functions of the plurality of ML engine(s) 150. In one example, the implementation engine 155 is configured to operate the data retrieval engine 151 so that the data retrieval engine 151 retrieves data at the appropriate time to be able to obtain audio 141 for the decoding engine 152 to process. The implementation engine 155 facilitates the process communication and timing of communication between one or more of the ML engine(s) 150 and is configured to implement and operate a machine learning model (or one or more of the ML engine(s) 150) which is configured as an automatic speech recognition system (ASR system 143).

The implementation engine 155 is configured to implement the decoding engine 152 to begin decoding the audio and is also configured to reset the decoder when a segment break has been generated. Additionally, the implementation engine 155 is configured to implement the scoring engine to generate segmentation scores and evaluate the segmentation scores against segmentation score thresholds. Finally, the implementation engine 155 is configured to implement the segmentation engine 154 to generate segment breaks and/or refrain from generating segment breaks based on the segmentation score evaluations.

By implementing the disclosed embodiments in this manner, many technical advantages over existing systems are realized, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

The computing system is in communication with third-party system(s) 120 comprising one or more processor(s) 122, one or more of the computer-readable instructions 118, and one or more hardware storage device(s) 124. It is anticipated that, in some instances, the third-party system(s) 120 further comprise databases housing data that could be used as training data, for example, audio data not included in local storage. Additionally, or alternatively, the third-party system(s) 120 include machine learning systems external to the computing system 110. The third-party system(s) 120 are software programs or applications.

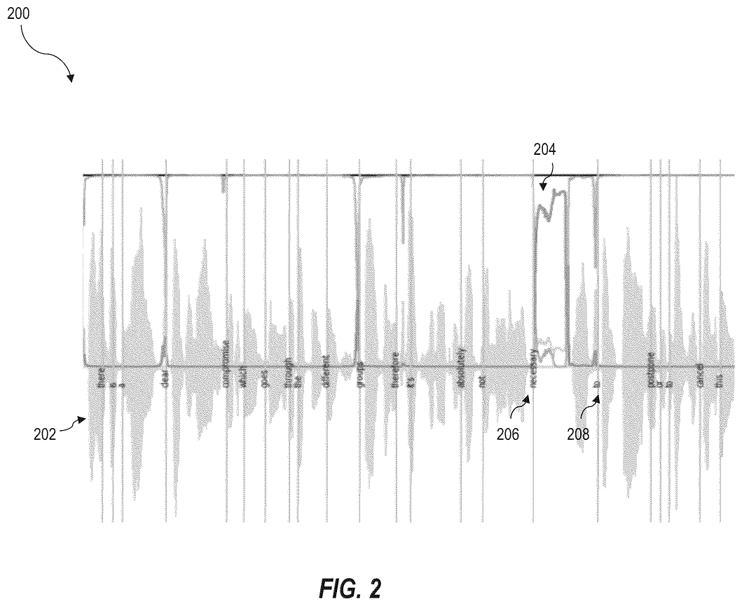

Attention will now be directed to FIG. 2, which illustrates an example embodiment of an audio 200 being analyzed for language and/or acoustic features in order to determine at which points to segment the audio. FIG. 2 shows a waveform 202 being analyzed for speech segmentation. Overlayed on the waveform is a line which signified the EOS (end-of-sentence) probability from the acoustic features (as output by the acoustic model). Using prosodic features, the system identifies a potential segmentation boundary at the word “groups”. For example, when the decoder reaches the word “groups”, the word sequence “There is a dear compromise which goes through different groups” appears to be a complete phrase, and the system will generate a segment break at the potential segmentation boundary. In this instance, the segment break is an accurate representation of the end of the speech utterance (e.g., sentence).

When segment from “there” to “groups” is sent to the punctuator, the punctuator is able to easily identify the start of the sentence with the word “there,” and will responsively change the punctuation of the word by capitalizing “there” to “There,” further signifying the start of a new sentence. The punctuator is also able to accurately place an ending punctuation (e.g., a period) at the end of the segment which corresponds to the segment break at “groups.” Because the segmentation model would not have sent any partial speech utterances to the punctuator, the punctuator output will be of higher quality and higher accuracy. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed.

In FIG. 2, the speech utterance following the word “groups” is more difficult to discern when to segment. There is a phrase, “therefore its absolutely not necessary” followed by “to postpone or to cancel this”. When the system arrives at the word “necessary”, the waveform shows that the user paused for a certain period of time (e.g., acoustic feature 204). Based on this acoustic feature 204 (i.e., a long pause) the acoustic model would give a very high segmentation probability. When the language model analyzes the phrase up until “necessary” 206, the language model segmentation score would also be high (i.e., individual high segmentation probability). Thus, only having analyzed up to the word “necessary” 206 and based on high segmentation probability scores from both the acoustic segmentation model and the language segmentation model, the system would determine to generate a segment break at the potential segmentation boundary identified at the word “necessary” 206. However, as shown, the speech utterance does not actually end at the word “necessary” 206 but rather ends at the word “this.”

To overcome this possible over-segmentation, the segmentation engine further analyzes one or more acousto-linguistic features occurring after the potential segmentation boundary identified at the word “necessary” 206. When the system analyzes the word “to” that follows “necessary” 206, the language segmentation score would decrease for the probability of segmentation since “necessary to” would be predicted to have a clause with several more following “to” 208. If the system analyzed further including the “look-ahead words” comprising “to postpone or to . . . ”, the system would determine that there should be a low linguistic segmentation score at the potential segmentation boundary identified at “necessary” 206. In such instances, the segmentation engine would refrain from generating a segment break at the potential segmentation boundary at “necessary” 206. This would be an accurate refraining from segmenting.

Thus, this functionality further improves the technical benefits realized wherein the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

In this manner, segmentation decisions are made based on considering words that appear in the future (i.e., after a potential segmentation boundary). Segmentations made using look-ahead words should not result in delaying all segmentations in the continuous speech contexts. Such delayed decisions for segmentations are possible for more than single word look-ahead analyzation. In such configurations, the systems are configured at run-time, wherein the quantity of speech following the potential segmentation boundary is determined based on user-input and/or based on an identified type or context associated with the audio being processed. Here, because delayed decisions are avoided, latencies in processing time are minimized, thereby increasing the efficiency of the computer processing and reducing processing time. This further improves the user experience when the systems are operating in streaming mode, where the output is real-time and easily readable.

The segmentation model is also able to take in further information about the audio and/or output from other audio processing models. For example, the use of a voice change detection could aid in providing information about when voice changes occur. This additional information assists the segmentation model in determining when to segment speech. This is especially beneficial for conversation and/or dialog transcription tasks. A voice change model is able to detect a voice change, wherein the segmentation model predicts a high probability of an end of speech utterance and can, therefore, determine where to generate a segment break. Thus, the disclosed embodiments provide many technical advantages over existing systems, including the ability to incorporate look-ahead words, along with other external contextual data, into segmenting phrases for continuous speech. The disclosed embodiments provide a way to produce semantically meaningful segments in the decoder which improves the quality of punctuation as well as machine translation quality.

Attention will now be directed to FIG. 3, which illustrates an example embodiment of a process flow diagram for determining when to segment audio. As illustrated, a computing system first identifies input speech 302 (e.g., audio) which is applied as input to an acoustic front-end model 304. The input speech 302 is then transmitted to the acoustic model 306.

Output from the acoustic model and a language model 308 are used to perform a search 310 from the recognition output 318 (e.g., sequence of words). Subsequent to being processed by the acoustic front-end, acoustic features associated with the input speech is analyzed by the segmentation acoustic model 312. Output from the segmentation acoustic model 312 and the segmentation language model 316 are used as part of the model-based segmentation 314. Output from the model-based segmentation is re-transmitted in order to perform a search when no segment break is generated.

The language segmentation model is trained with an N-word offset. For N=1, the language segmentation model analyzes up to one look-ahead word occurring after a potential segmentation boundary. For an N=2 offset, the language segmentation model analyzes up to two look-ahead words occurring after a potential segmentation boundary, etc. Referring back to FIG. 3, for N=1, when the system identifies the potential segmentation boundary at “necessary”, the system analyzes the phrase “therefore its absolutely not necessary to”. The language segmentation model then calculates a language segmentation score that represents the probability of an end of speech (EOS) at the T−1^{th} word (e.g., “necessary”) where T is the end of the phrase including the look-ahead word.

If the LM-EOS (language model-end of sentence) or language segmentation score is low, then the system continues to process the audio with generating a segment break at the potential segmentation boundary, even if the acoustic segmentation score is high for that potential segmentation boundary. However, if the language segmentation score is high (i.e., indicating that the T−1^{th} word will be a good point to segment), the system will generate a segment break at the potential segmentation boundary located at the T−1^{th} word). In some instances, the system will only generate a segment break if both the acoustic segmentation score and the language segmentation score are high.

Since the acoustic front-end model 304 will have already processed the frames until the T^{th} word (e.g., up until the last look-ahead word), the decoder is configured to reset and start decoding the frames after the segmented T−1^{th} word boundary. In this configuration, the system does not have to rewind the audio (e.g., input speech 302) and reprocess the audio redundantly in the acoustic front-end model 304. This is beneficial because whenever the LM-EOS doesn't trigger a segment break generation, there will be no change in latency of the processing of the input speech 302. Only when a segmentation event occurs that requires the decoder to process a few extra frames between the last word would it impact the perceived latency in speech processing.

As shown in FIG. 3, segmentation decisions are time-synchronous with the decoder (e.g., acoustic front-end). In some instances, the segmentation analysis is triggered by the segmentation acoustic model 312 with a “yes/no” vote from the segmentation language model 316 based on a word sequence since the start of the most recent segmentation or start of the input speech 302. In some instances, the acoustic front-end model 304 is reset at each segmentation event.

In some embodiments, the segmentation decision is triggered by the segmentation language model 316 with additional computations. For example, a “yes/no” vote from the segmentation acoustic model 312 is archived based off of the word boundaries between the end of the previous word and beginning of a current word. The system chooses the earliest possible frame of the input speech 302. The decoder is then rewound to the chosen frame. Subsequently, or simultaneously, the acoustic model 306 is also reset to the chosen frame. For every intermediate frame, the system caches the states until a new word appears. If the system determines not to generate a segment break at the previous word, the cached state is updated to reflect the most current word. If the system determines to generate a segment break, then the decoding is restarted from that newest point of segmentation.

As shown in FIG. 3, audio that is segmented according to illustrated methods with illustrated systems provide technical advantages over conventional systems. The disclosed embodiments provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

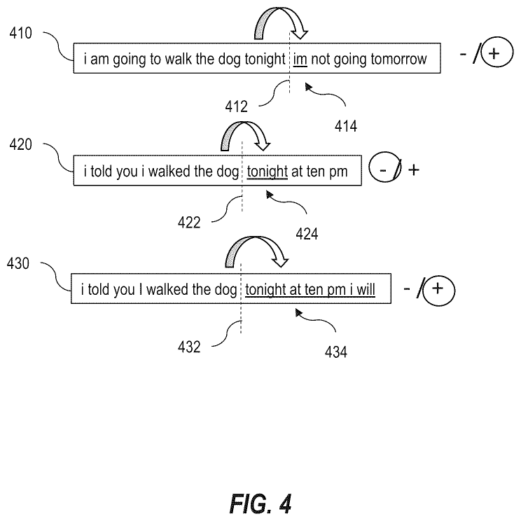

Attention will now be directed to FIG. 4, which illustrates various example embodiments of identifying a potential segmentation boundary and generating an acoustic and/or language score segmentation based on one or more look-ahead words. For example, input audio 410 comprises “I am going to walk the dog tonight im not going tomorrow”. The system identifies a potential segmentation boundary 412 just after the detected word “tonight” and before the detected word “im” (e.g., look-ahead word 414). In an N=1 configuration, the system looks ahead to the word “im” and generates a language segmentation score based on how likely the potential segmentation boundary at “tonight” would be an accurate end-of-sentence segmentation. In this example, “im” is not a typical start to a new clause, but rather the start of a new speech utterance. Thus, the language segmentation model would calculate a high language segmentation score. If that language segmentation score meets or exceeds the language segmentation score threshold, the system will generate a segment break at the potential segmentation boundary 412.

In another example, input speech 420 comprises “I told you I walked the dog tonight at ten pm”. The system identifies a potential segmentation boundary 422 at the word “dog” and will look ahead to one look-ahead word 424 comprising “tonight”. The system then analyzes the phrase “I told you I walked the dog tonight” and determines how likely the potential segmentation boundary at “dog” is an end-of-sentence indication. In this example, the system returns a low language segmentation score and refrains from generating a segment break at the potential segmentation boundary 422. However, when the system analyzes more than one look-ahead word, the system returns a different, higher language segmentation score. For example, in input speech 430, the system is configured to look-ahead at least 6 words (e.g., look-ahead words 434). A potential segmentation boundary 432 is identified at “dog” and the system considers the whole input speech “I told you I walked the dog tonight at ten pm I will”. Because the phrase “tonight at ten pm I will” is likely the beginning of a new sentence, the system calculates a high language segmentation score for the potential segmentation boundary 432. If the language segmentation score meets or exceeds a language segmentation score threshold, the system will generate a segment break at the potential segmentation boundary 432.

Thus, systems that segment audio based on a tunable number of look-ahead words, as shown in FIG. 4, provide technical advantages over conventional systems. The disclosed embodiments provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation.

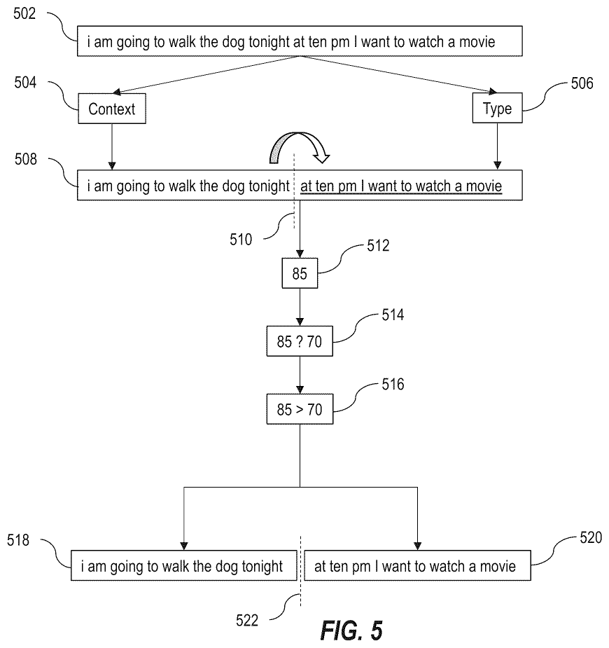

This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode. These technical benefits are further explained below, in reference to FIG. 5.

Attention will now be directed to FIG. 5, which illustrates an example embodiment of identifying a potential segmentation boundary and determining whether to generate a segment break based on a context and/or type associated with the audio. Systems obtain audio (i.e., input speech) comprising “I am going to walk the dog tonight at ten pm I want to watch a movie.” The system identifies a context 504 and a type 506 associated with the audio. For example, the system can identify the context 504 to be a speech-to-text transcription, and the type 506 is identified as a pre-recorded voicemail.

Because the transcription process is for a pre-recorded voicemail and will likely output a completed transcript to the user, the system is able to look at a larger quantity of look-ahead words because latency in speech processing will not be as noticeable or interfere with the user experience. However, if the transcription process was for live-captioning of a live stream of continuous speech, the system would beneficially only look at one or a limited number of look-ahead words when determining segmentation to keep any latency costs at a minimum.

The system identifies a potential segmentation boundary 510 at the word “tonight” within the audio portion 508 and is configured to analyze up to 9 look-ahead words occurring after the potential segmentation boundary 510. Thus, the system analyzes the complete audio 502 when determining whether or not to generate a segment break at the potential segmentation boundary 510. The system then calculates a language segmentation score 512 (e.g., “85”) based on the linguistic correlation between the phrase “I am going to walk the dog tonight” and “at ten pm I want to watch a movie”. The system then evaluates the language segmentation score against the language segmentation score threshold (e.g., evaluation 514) which is set at 70. The system determines that the language segmentation score 512 exceeds the language segmentation score threshold (e.g., result 516). The system then generates a segment break 522 between “tonight” and “at”, wherein two segments are generated (e.g., segment 518 and segment 520).

It should be appreciated that evaluative process shown in FIG. 5 is also applicable to calculating and evaluating an acoustic segmentation score. In some instances, the acoustic segmentation score is calculated before calculating the language segmentation score. In some instances, the acoustic segmentation score is calculated after the language segmentation score is calculated. In some instances, only the acoustic or the language segmentation score is calculated. Alternatively, the system can calculate the acoustic and language segmentation score independently from one another.

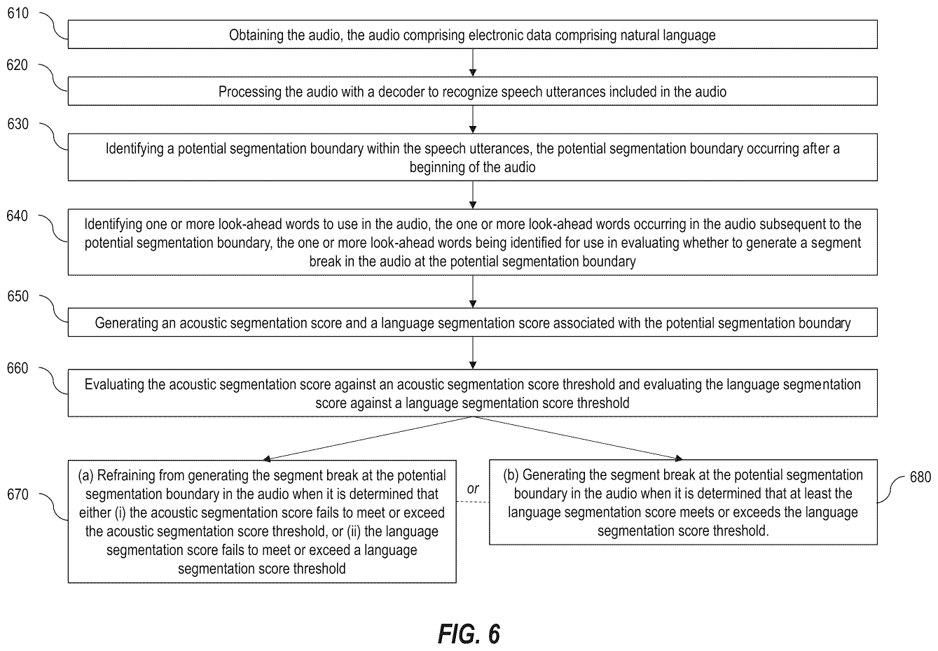

Attention will now be directed to FIG. 6 which illustrates a flow diagram 600 that includes various acts (act 610, act 620, act 630, act 640, act 650, act 660, act 670, and act 680) associated with exemplary methods that can be implemented by computing system 110 for segmenting audio.

The first illustrated act includes an act of obtaining audio that includes electronic data comprising natural language (act 610). The computing system processes the audio with a decoder to recognize speech utterances included in the audio (act 620). A potential segmentation boundary is identified within the speech utterances (act 630). The potential segmentation boundary occurs after beginning of the audio. After identifying the potential segmentation boundary, the computing system identifies one or more look-ahead words to use in the audio (act 640). The one or more look-ahead words are identified for use in evaluating whether to generate a segment break in the audio at the potential segmentation boundary. The computing system also generates an acoustic segmentation score and a language segmentation score associated with the potential segmentation boundary (act 650).

After generating the different segmentation scores, the computing system evaluates the acoustic segmentation score against an acoustic segmentation score threshold and evaluates the language segmentation score against a language segmentation score threshold (act 660). When it is determined that either (i) the acoustic segmentation score fails to meet or exceed the acoustic segmentation score threshold, or (ii) the language segmentation score fails to meet or exceed the language segmentation score threshold, the computing system refrains from generating the segment break at the potential segmentation boundary (act 670). Alternatively, when it is determined that at least the language segmentation score meets or exceeds the language segmentation score threshold, the computing system generates the segment break at the potential segmentation boundary in the audio (act 680).

As shown in FIG. 6, audio that is segmented according to illustrated methods with illustrated systems provide technical advantages over conventional systems. The disclosed embodiments provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

The computing system is configured to obtain different types of audios including continuous live streams of natural language audio and/or previously recorded audio datasets. The audio is then decoded using a decoder, which is reset to begin recognizing new speech utterances in the natural language starting at the segment break after a new segment break is generated at a previously identified potential segmentation boundary. Thus, because the computing system is able to obtain and segment different types of audios, the system is configured as a universal system that is applicable to any number of real-world audio scenarios. Furthermore, because the systems detect and distinguish between different types of audio, the systems are able to tune downstream processes according to parameters that are tunable based on the type of audio (see methods for determining an amount of look-ahead words).

The potential segmentation boundary is identifiable based on different acoustic and/or language features associated with the audio. In some instances, the potential segmentation boundary is identified based on a prediction that the potential segmentation boundary corresponds to an end of speech utterance included in the audio, such that one or more acoustic features occurring before the potential segmentation boundary have a low correlation to one or more different acoustic features occurring after the potential segmentation boundary. With this innovation where the segmentation engine “looks ahead” past a potential segmentation boundary, the systems can detect the utterance of a clause and prevent early segmentation. This leads to better readability of the text after the speech utterances are transcribed.

Additionally, or alternatively, the potential segmentation boundary is identified based on a prediction that the potential segmentation boundary corresponds to an end of speech utterance included in the audio such that one or more language features occurring before the potential segmentation boundary have a low correlation to one or more language features occurring after the potential segmentation boundary. With this innovation where the segmentation engine “looks ahead” past a potential segmentation boundary, the systems can detect the utterance of a clause and prevent early segmentation. This leads to better readability of the text after the speech utterances are transcribed.

After a potential segmentation boundary is identified through one or more methods described herein, the computing system evaluates the potential segmentation boundary and determines whether to generate a segment break at the potential segmentation boundary. The potential word boundary occurs after a beginning of the audio. In some instances, the beginning of the audio is located at a previously generated segment break. Alternatively, the beginning of the audio is a start of a previously recorded audio file, and/or the beginning of the audio is a start of a new audio stream. Evaluating the potential segmentation boundary in this manner provides many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality.

The computing system evaluates the potential segmentation boundary and determines whether to generate a segment break at the potential segmentation boundary based on the acoustic segmentation score and/or the language segmentation score. The acoustic segmentation score and language segmentation may be calculated simultaneously or concurrently. In other instances, the acoustic segmentation score and language segmentation occur in a sequential ordering (with one process being completed before the other begins). In some instances, the computing system determines to calculate the language segmentation score associated with the potential segmentation boundary in response to determining that the acoustic segmentation score at least meets or exceeds the acoustic segmentation score threshold. Because the determination for segmentation is based on a customizable manner of calculating the segmentation scores and subsequent evaluation of the segmentation score based on the type of audio that is detected, the systems are able to produce more accurate segment breaks, prevent over-segmentation, prevent under-segmentation, and produce higher quality output for downstream application such as machine translation, punctuators, etc.

In such configurations, if the acoustic segmentation score does not at least meet or exceed the acoustic segmentation score, the language segmentation score is not calculated. This is because if a potential segmentation boundary is associated with a low acoustic segmentation score, then it is likely that a language segmentation score likely would not meet or exceed the language segmentation score threshold. However, the computing system is also configurable to only calculate the language segmentation score and/or calculate the acoustic segmentation score only after determining that the language segmentation score at least meets or exceeds the language segmentation score threshold. Thus, the acoustic and/or language segmentation scores are used in determining whether to generate a segment break at the potential segmentation boundary.

Furthermore, in some instances, systems compute a joint acousto-linguistic combination segmentation score. In such instances, the joint acousto-linguistic segmentation score is computed additionally, or alternatively, to the acoustic segmentation score, the language segmentation, or both the acoustic segmentation score and the language segmentation score. The joint acousto-linguistic segmentation score is calculable according to different methods. For example, the joint acousto-linguistic score is calculated independent of the acoustic segmentation and/or language segmentation score.

Alternatively, the joint acousto-linguistic segmentation score is calculated based on a combination of the acoustic segmentation score and language segmentation score. Subsequent to calculating the joint acousto-linguistic segmentation score, the computing systems evaluate the joint acousto-linguistic segmentation score against a joint acousto-linguistic score threshold. In some configurations, systems also evaluate the joint acousto-linguistic segmentation score against the corresponding score threshold in combination with any time-based signals (say an elapsed time duration where no new words have been detected). In configurations where systems generate a joint acousto-linguistic score, systems refrain from

In some instances, the computing system uses the segment break to generate a particular segment of the audio. The goal of the computing system is that the particular segment of the audio corresponds to a particular speech utterance included in the audio, such that the particular segment starts at the beginning of the speech utterance and ends at the end of the speech utterance. In this manner, the particular segment includes the complete speech utterance. In some instances, the particular segment includes multiple complete speech utterances, partial speech utterances, or a combination of complete and partial speech utterances. The audio may comprise a single segment or multiple segments. Where there are multiple segments, the particular segment break starts at the beginning of the audio and ends at the segment break. The disclosed embodiments provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality.

For example, after the particular segment is generated, the computing system transmits the particular segment of the audio to a punctuator which is configured to generate one or more punctuation marks within the particular segment of the audio. Ideally, punctuator determines that an end punctuation is needed at the end of the segment break (where the segment break comprises at least one complete speech utterance). For example, wherein the particular segment comprises a single sentence, the computing system generates a punctuation mark that corresponds to an end of the single sentence. The end of the single sentence is located at the segment break.

Alternatively, when the particular segment comprises multiple sentences, the computing system recognizes one or more sentences within the particular segment and generates one or more punctuation marks to be places at an end of each of the one or more sentences included in the particular segment.

With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

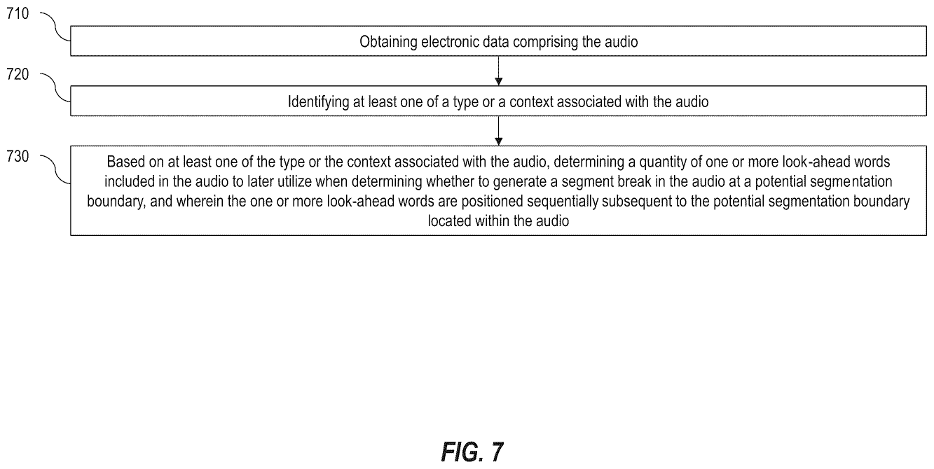

Attention will now be directed to FIG. 7 which illustrates a flow diagram 700 that includes various acts (act 710, act 720, and act 730) associated with exemplary methods that can be implemented by computing system 110 for determining how far to look ahead in the audio (e.g., how many one or more look-ahead words to use) in an analysis of whether to generate a segment break in an audio at a potential segmentation boundary.

The first illustrated act includes an act wherein the computing system obtain electronic data comprising audio (act 710). The computing system then identifies at least one of a type or a context associated with the audio (act 720). Subsequent to identifying the type and/or the context associated with the audio, the computing system determines a quantity of one or more look-ahead words included in the audio to later utilize when determining whether to generate a segment break in the audio at a potential segmentation boundary based on at least one of the type or the context associated with the audio (act 730). In such configurations, the one or more look-ahead words are positioned sequentially subsequent to the potential segmentation boundary within the audio.

Implementing systems in this manner, as shown in FIG. 7, provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

The computing system is able to obtain and distinguish between many types of audios. Different types of audios include continuous streams of natural language audio and previously recorded audio datasets. Sometimes the previously recorded audio dataset is a voicemail. The computing system is also able to obtain and distinguish between different contexts associated with the audio. Some audio is associated with a context such that the one or more recognized speech utterances included in the audio are used for a real-time audio transcription from audio data to text data. The audio data can be a live stream or, alternatively, a previously recorded audio transcription that is being streamed. Another context that the computing system can identify is when one or more recognized speech utterances included in the audio are to be used for a real-time translation from a first language to a second language.

Thus, because the computing system is able to obtain and segment different types of audios, the system is configured as a universal system that is applicable to any number of real-world audio scenarios. Furthermore, because the systems detect and distinguish between different types of audio, the systems are able to tune downstream processes according to parameters that are tunable based on the type of audio (see methods for determining an amount of look-ahead words).

Furthermore, in some instances, the quantity of one or more look ahead words is determined based on a pre-determined amount of time that the quantity of one or more look-ahead words comprises. For example, the computing system could determine that it needs to analyze at least 10 seconds of audio occurring after the potential segmentation boundary, wherein 5 words are identified within the 10 seconds of audio after the potential segmentation boundary. Systems configured in this manner are then adaptable according to a number of words, an amount of time, or other determining factor in determining how far past the potential segmentation boundary to “look-ahead” when calculating one or more of the segmentation scores. This adaptability of the systems maintains and improves system operation regardless of the type of input audio that it is analyzing. Furthermore, this improves the user experience because when a system does not need to look-ahead as much, latency in processing times is reduced. On the other hand, when the system determines that a larger look-ahead amount is acceptable, this improves the accuracy of the segmentation, thus improving the quality of speech recognition output to the user.

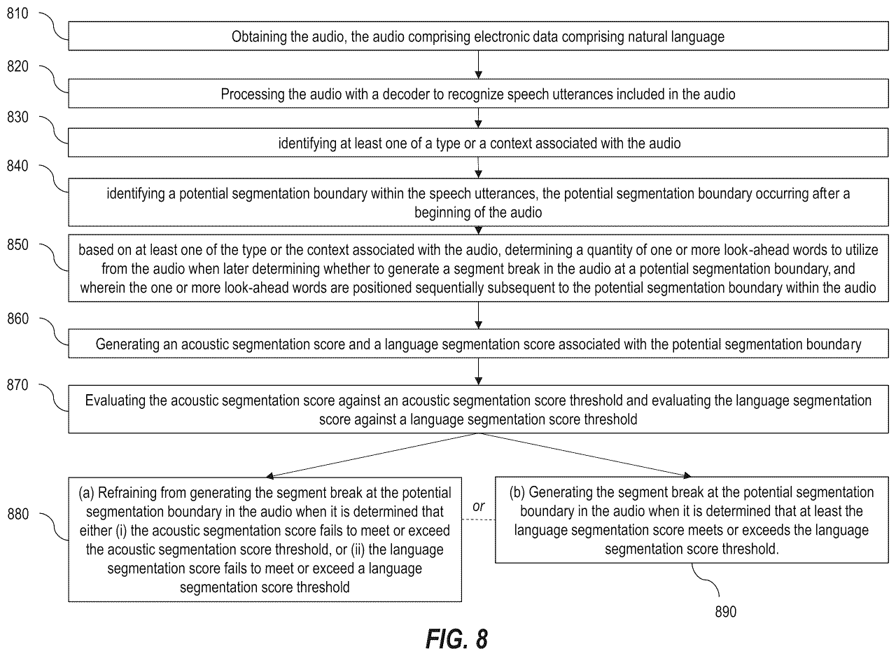

Attention will now be directed to FIG. 8 which illustrates a flow diagram 800 that includes various acts (act 810, act 820, act 830, act 840, act 850, act 860, act 870, and act 880) associated with exemplary methods that can be implemented by computing system 110 for segmenting audio. As illustrated, flow diagram 800 includes various acts that are representative of a combination of flow diagrams 600 and 800. For example, act 810 is representative of act 610 and/or act 710. Act 820 is representative of act 620. Act 830 and act 850 are representative of act 720 and act 730, respectively. Act 840, act 860, act 870, act 880, and act 890 are representative of act 630, act 650, act 660, act 670, and act 680, respectively. It should be appreciated that the computing system is able to identify at least one of a type or a context associated with the audio (act 830) in parallel or in sequence with (i.e., previous, or subsequent to) processing the audio with a decoder to recognize speech utterances included in the audio.

As shown in FIG. 8, the disclosed embodiments provide many technical advantages over existing systems, including the ability to incorporate smart technology into segmenting phrases for continuous speech. The disclosed embodiments provide a way to produce semantically meaningful segments in the decoder which improves the quality of punctuation as well as machine translation quality. With this innovation where the segmentation engine “looks ahead” past a potential segmentation boundary, the systems can detect the utterance of a clause and prevent early segmentation. This leads to better readability of the text after the speech utterances are transcribed. Improvement of segmentation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode.

In view of the foregoing, it will be appreciated that the disclosed embodiments provide many technical benefits over conventional systems and methods for segmentation of continuous speech by using a recurrent model that analyzes one or more look-ahead words to determine whether or not to generate a segment break at a potential segmentation boundary identified in the continuous speech. Thus, the disclosed embodiments can be utilized to beneficially improve upon conventional techniques for segmenting audio for facilitating improvements in the quality of operations associated with video conference calling, for example, with real-time transcriptions, as well as other types of speech-to-text applications. The disclosed systems can also be used to facilitate better segmented speech to further improve upon the quality of speech recognition, in order to facilitate better understanding of context and meaning and also for using speech as a natural user interface.

### Example Computing Systems

Embodiments of the present invention may comprise or utilize a special purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., hardware storage device(s) 140 of FIG. 1) that store computer-executable instructions (e.g., computer-readable instructions 118 of FIG. 1) are physical hardware storage media/devices that exclude transmission media. Computer-readable media that carry computer-executable instructions or computer-readable instructions (e.g., computer-readable instructions 118) in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method implemented by a computing system for segmenting audio, the method comprising:
a computing system obtaining audio, the audio including electronic data comprising natural language;
the computing system processing the audio with a decoder to recognize speech utterances included in the audio;
the computing system identifying a potential segmentation boundary within the speech utterances, the potential segmentation boundary occurring after a beginning of the audio;
the computing system identifying one or more look-ahead words to use in the audio, the one or more look-ahead words occurring in the audio subsequent to the potential segmentation boundary, the one or more look-ahead words being identified for use in evaluating whether to generate a segment break in the audio at the potential segmentation boundary;
the computing system generating an acoustic segmentation score and a language segmentation score associated with the potential segmentation boundary;
the computing system evaluating the acoustic segmentation score against an acoustic segmentation score threshold and evaluating the language segmentation score against a language segmentation score threshold; and
the computing system (a) refraining from generating the segment break at the potential segmentation boundary in the audio when it is determined that either (i) the acoustic segmentation score fails to meet or exceed the acoustic segmentation score threshold, or (ii) the language segmentation score fails to meet or exceed the language segmentation score threshold, or
alternatively, (b) generating the segment break at the potential segmentation boundary in the audio when it is determined that at least the language segmentation score meets or exceeds the language segmentation score threshold.

2. The method of claim 1, wherein the audio is a continuous live stream of natural language audio.

3. The method of claim 1, wherein the audio is a previously recorded audio dataset.

4. The method of claim 1, further comprising:
the computing system resetting the decoder to begin recognizing new speech utterances in the natural language starting at the segment break.

5. The method of claim 1, wherein the potential segmentation boundary is identified based on a prediction that the potential segmentation boundary corresponds to an end of speech utterance included in the audio such that one or more acoustic features occurring before the potential segmentation boundary have a low correlation to one or more different acoustic features occurring after the potential segmentation boundary.

6. (canceled)

7. The method of claim 1, wherein the beginning of the audio is located at a previously generated segment break.

8. The method of claim 1, further comprising:
the computing system determining to calculate the language segmentation score associated with the potential segmentation boundary in response to determining that the acoustic segmentation score at least meets or exceeds the acoustic segmentation score threshold.

9. The method of claim 1, further comprising:
the computing system using the segment break to generate a particular segment of the audio, the particular segment starting at the beginning of the audio and ending at the segment break.

10. The method of claim 9, further comprising:
the computing system transmitting the particular segment of the audio to a punctuator which is configured to generate one or more punctuation marks within the particular segment of the audio.

11. The method of claim 10, wherein the particular segment comprises a single sentence, further comprising:
the computing system generating a punctuation mark that corresponds to an end of the single sentence, wherein the end of the single sentence is located at the segment break.

12. The method of claim 10, wherein the particular segment comprises multiple sentences, further comprising:
the computing system recognizing one or more sentences within the particular segment; and
the computing system generating one or more punctuation marks to be placed at an end of each of the one or more sentences included in the particular segment.

13. A computer-implemented method for determining how many one or more look-ahead words to use in an analysis of whether to generate a segment break in an audio at a potential segmentation boundary, method comprising:
a computing system obtaining electronic data comprising the audio;
the computing system identifying at least one of a type or a context associated with the audio; and
the computing system determining a quantity of one or more look-ahead words included in the audio to later utilize when determining whether to generate a segment break in the audio at a potential segmentation boundary based on at least one of the type or the context associated with the audio, wherein the one or more look-ahead words are positioned sequentially after the potential segmentation boundary within the audio.

14. The method of claim 13, wherein the type of the audio is a continuous stream of natural language audio.

15. A computer-implemented method for segmenting audio, the method being implemented by a computing system, the method comprising:
a computing system obtaining the audio, the audio comprising electronic data comprising natural language;
the computing system processing the audio with a decoder to recognize speech utterances included in the audio;
the computing system identifying at least one of a type or a context associated with the audio;
the computing system identifying a potential segmentation boundary within the speech utterances, the potential segmentation boundary occurring after a beginning of the audio;
based on at least one of the type or the context associated with the audio, determining a quantity of one or more look-ahead words to utilize from the audio when later determining whether to generate a segment break in the audio at a potential segmentation boundary, and wherein the one or more look-ahead words are positioned sequentially subsequent to the potential segmentation boundary within the audio;
the computing system generating an acoustic segmentation score and a language segmentation score associated with the potential segmentation boundary;
the computing system evaluating the acoustic segmentation score against an acoustic segmentation score threshold and evaluating the language segmentation score against a language segmentation score threshold; and
the computing system (a) refraining from generating the segment break at the potential segmentation boundary in the audio when it is determined that either (i) the acoustic segmentation score fails to meet or exceed the acoustic segmentation score, or (ii) the language segmentation score fails to meet or exceed a language model segmentation score threshold, or
alternatively, (b) generating the segment break at the potential segmentation boundary in the audio when it is determined that at least the language segmentation score meets or exceeds the language segmentation score threshold.

16. A computing system comprising one or more hardware processors and one or more storage device having stored instructions that are executable by the one or more hardware processors for causing the computing system to implement a method for segmenting audio, and by at least causing the computing system to perform acts including:
obtaining audio, the audio including electronic data comprising natural language;
processing the audio with a decoder to recognize speech utterances included in the audio;
identifying a potential segmentation boundary within the speech utterances, the potential segmentation boundary occurring after a beginning of the audio;
identifying one or more look-ahead words to use in the audio, the one or more look-ahead words occurring in the audio subsequent to the potential segmentation boundary, the one or more look-ahead words being identified for use in evaluating whether to generate a segment break in the audio at the potential segmentation boundary;
generating an acoustic segmentation score and a language segmentation score associated with the potential segmentation boundary;
evaluating the acoustic segmentation score against an acoustic segmentation score threshold and evaluating the language segmentation score against a language segmentation score threshold; and
(a) refraining from generating the segment break at the potential segmentation boundary in the audio when it is determined that either (i) the acoustic segmentation score fails to meet or exceed the acoustic segmentation score threshold, or (ii) the language segmentation score fails to meet or exceed the language segmentation score threshold, or
alternatively, (b) generating the segment break at the potential segmentation boundary in the audio when it is determined that at least the language segmentation score meets or exceeds the language segmentation score threshold.

17. The computing system of claim 16, wherein the instructions are further executable by the one or more hardware processors for causing the computing system to reset the decoder to begin recognizing new speech utterances in the natural language starting at the segment break.

18. The computing system of claim 16, wherein the potential segmentation boundary is identified based on a prediction that the potential segmentation boundary corresponds to an end of speech utterance included in the audio such that one or more acoustic features occurring before the potential segmentation boundary have a low correlation to one or more different acoustic features occurring after the potential segmentation boundary.

19. The computing system of claim 16, wherein the instructions are further executable by the one or more hardware processors for causing the computing system to calculate the language segmentation score associated with the potential segmentation boundary in response to determining that the acoustic segmentation score at least meets or exceeds the acoustic segmentation score threshold.

20. The computing system of claim 16, wherein the instructions are further executable by the one or more hardware processors for causing the computing system to use the segment break to generate a particular segment of the audio, the particular segment starting at the beginning of the audio and ending at the segment break.

21. The computing system of claim 16, wherein the instructions are further executable by the one or more hardware processors for causing the computing system to transmit the particular segment of the audio to a punctuator which is configured to generate one or more punctuation marks within the particular segment of the audio.
